(19) United States
(12) Patent Application Publication
(10) Pub. No.: US 2012/0166464 A1
(43) Pub. Date: Jun. 28, 2012

(54) METHOD AND APPARATUS FOR PROVIDING INPUT SUGGESTIONS

(75) Inventors: Jukka Honkola, Espoo (FI); Vesa-Veikko Luukkala, Espoo (FI); Sergey Boldyrev, Soderkulla (FI); Mika Juhani Mannermaa, Burlington, MA (US); Hannu Ensio Laine, Espoo (FI); Ian Justin Oliver, Soderkulla (FI)

(73) Assignee: Nokia Corporation, Espoo (FI)

(21) Appl. No.: 13/332,763

(22) Filed: Dec. 21, 2011

Related U.S. Application Data
(60) Provisional application No. 61/427,340, filed on Dec. 27, 2010.

(51) Int. Cl. G06F 17/30

(52) U.S. Cl. 707/758; 707/E17.005

(57) ABSTRACT

An approach is provided for providing input suggestions. An input generating platform causes, at least in part, presentation of a user interface element including at least one input field. The input generating platform also determines at least one field type associated with the at least one input field. The input generating platform further identifies at least one information store, context store, or a combination thereof based, at least in part, on the at least one field type. The input generating platform also determines to migrate one or more computations for generating one or more suggestions, one or more default values, or a combination thereof for populating the at least one input field, generating the user interface element, or a combination thereof to the at least one information store, context store, or a combination thereof.

### RELATED APPLICATIONS

This application claims the benefit of the earlier filing date under 35 U.S.C. §119(e) of U.S. Provisional Application Ser. No. 61/427,340 filed Dec. 27, 2010, entitled “Method and Apparatus for Providing Input Suggestions,” the entirety of which is incorporated herein by reference.

### BACKGROUND

Service providers (e.g., wireless, cellular, etc.) and device manufacturers are continually challenged to deliver value and convenience to consumers by, for example, providing compelling network services. One area of interest has been the development of information and computation spaces (e.g., smart spaces) for distributed information management and computing. By way of example, it is noted that various devices (e.g., mobile devices) with various methods of connectivity are now for many people becoming the primary gateway to the internet and also a major storage point for personal information. This is in addition to the normal range of personal computers and furthermore sensor devices plus internet based providers. Combining these devices together and the applications and the information stored by those applications is a major challenge of interoperability. This can be achieved through numerous, individual and personal information or computation spaces in which persons, groups of persons, etc. can place, share, interact and manipulate webs of information with their own locally agreed semantics without necessarily conforming to an unobtainable, global whole. With the growing use of such distributed information and computation spaces, service providers and device manufacturers are challenged to leverage these information and computation spaces to support customers needs and provide accurate information to them in due time. For example, providing relevant input suggestions to the customers can greatly improve user experience and increase efficiency of access to high volumes of distributed information.

On the other hand, mobile devices used by customers for accessing the distributed information and computations are typically equipped with small keyboards or keypads that could make data entry a difficult, error prone and time consuming task.

### Some Example Embodiments

Therefore, there is a need for an approach for providing input suggestions wherein the suggestion list is dynamically generated with high probability of including useful entries for the customer to choose from.

According to one embodiment, a method comprises causing, at least in part, presentation of a user interface element including at least one input field. The method also comprises determining at least one field type associated with the at least one input field. The method further comprises identifying at least one information store, context store, or a combination thereof based, at least in part, on the at least one field type. The method also comprises determining to migrate one or more computations for generating one or more suggestions, one or more default values, or a combination thereof for populating the at least one input field, generating the user interface element, or a combination thereof to the at least one information store, context store, or a combination thereof.

According to another embodiment, an apparatus comprises at least one processor, and at least one memory including computer program code, the at least one memory and the computer program code configured to, with the at least one processor, cause, at least in part, the apparatus to cause, at least in part, presentation of a user interface element including at least one input field. The apparatus is also caused to determine at least one field type associated with the at least one input field. The apparatus is further caused to identify at least one information store, context store, or a combination thereof based, at least in part, on the at least one field type. The apparatus is also caused to determine to migrate one or more computations for generating one or more suggestions, one or more default values, or a combination thereof for populating the at least one input field, generating the user interface element, or a combination thereof to the at least one information store, context store, or a combination thereof.

According to another embodiment, a computer-readable storage medium carries one or more sequences of one or more instructions which, when executed by one or more processors, cause, at least in part, an apparatus to cause, at least in part, presentation of a user interface element including at least one input field. The apparatus is also caused to determine at least one field type associated with the at least one input field. The apparatus is further caused to identify at least one information store, context store, or a combination thereof based, at least in part, on the at least one field type. The apparatus is also caused to determine to migrate one or more computations for generating one or more suggestions, one or more default values, or a combination thereof for populating the at least one input field, generating the user interface element, or a combination thereof to the at least one information store, context store, or a combination thereof.

According to another embodiment, an apparatus comprises means for causing, at least in part, presentation of a user interface element including at least one input field. The apparatus also comprises means for determining at least one field type associated with the at least one input field. The apparatus further comprises means for identifying at least one information store, context store, or a combination thereof based, at least in part, on the at least one field type. The apparatus also comprises means for determining to migrate one or more computations for generating one or more suggestions, one or more default values, or a combination thereof for populating the at least one input field, generating the user interface element, or a combination thereof to the at least one information store, context store, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing input suggestions, according to one embodiment;

FIG. 2 is a diagram of the components of input generating platform, according to one embodiment;

FIG. 3 is a flowchart of a process for providing input suggestions, according to one embodiment;

FIG. 4 is a diagram of input field rendering, according to one embodiment;

FIG. 5 is a flowchart of generating input suggestions, according to one embodiment;

FIGS. 6A-6B are diagrams of computation migration, according to various embodiments;

FIG. 7 is a diagram of an ontology for storing semantic information of input fields, according to one embodiment.

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing input suggestions are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

In one embodiment, computational processes are subdivided (e.g., a minimum unit of code that can be used to perform a task or function of the process). By way of example, granularity (e.g., a minimum level of granularity, different levels of granularity, etc.) of the processes can be defined by the developer of the process or can be dynamically determined by a system. A particular computation procedure together with relations and communications among various processes including passing arguments, sharing process results, flow of data and process results, etc. is often referred to as a computation closure. The computation closures (e.g., a granular reflective set of instructions, data, and/or related execution context or state) provide the capability of slicing of computations for processes and transmitting the computation slices between devices, infrastructures and information (or context) stores.

As used herein, the term computation space refers to an aggregated set of computation closures from different sources. Similarly, the term information space refers to an aggregated information set from different sources. This multi-sourcing is very flexible since it accounts and relies on the observation that the same piece of information can come from different sources. In one embodiment, computations and information within the information management environment is represented using standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It has come to be used as a general method for conceptual description or modeling of information that is implemented in web resources; using a variety of syntax formats.

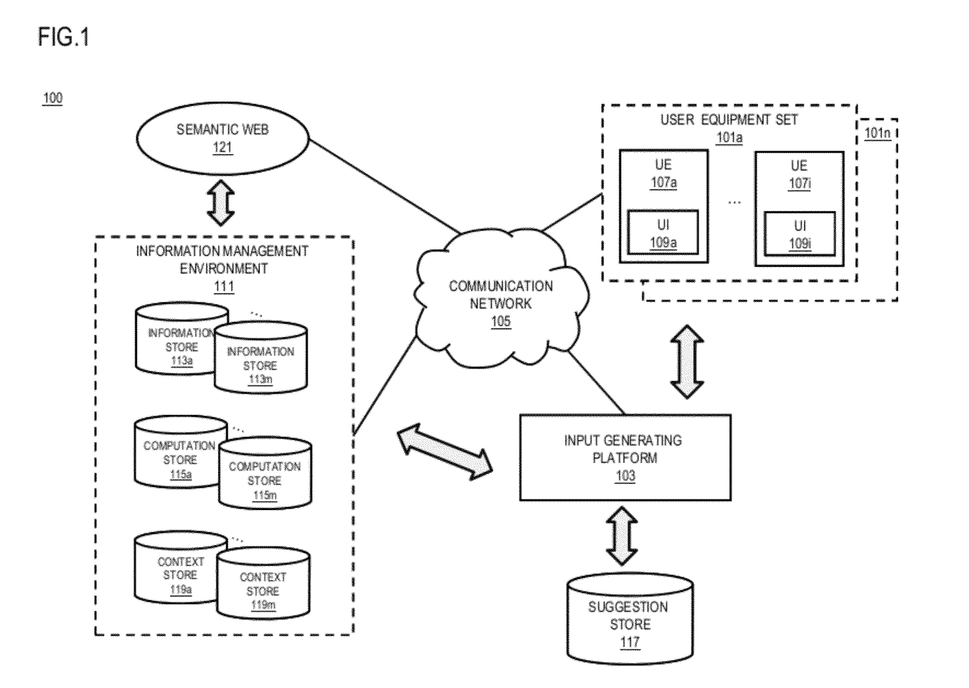

FIG. 1 is a diagram of a system capable of providing input suggestions, according to one embodiment. As used herein, the term information management environment refers to a universal medium for data, information, knowledge, and computations, wherein the data, information, knowledge and computations may be distributed within multiple devices in different locations and accessed by users via the communication network. An information management environment may consist of information and computation spaces each consisting of several distributed devices that communicate information and computation closures (e.g. RDF graphs) via one or more shared memories. A device within an information management environment may store computation closures locally in its own memory space or publish computation closures on a globally accessible environment within the information management environment. In the first case, the device is responsible for any process needed for combination or extraction of computations, while in the second case the processes can be conducted by the globally accessible environment. However, in many cases, the computation closures may be organized as lists or sets that can include many computation elements (e.g., computation closures related to search engines, data mining, data discovery, etc.).

In one embodiment, distributed information and/or computation technologies provide access to distributed computations and information for various devices within the scope of the information management environment, in such a way that the distributed nature of the computations is hidden from users and it appears to a user as if all the computations are performed on the same device. The computation space also enables a user to have control over computation distribution by transferring computations between devices that the user has access to. For example, a user may want to transfer computations among work devices, home devices, and portable devices. Furthermore, the computation spaces enables a computing environment to break complex and resource consuming computations into smaller and/or simpler sub-processes and have the sub-process computations performed over multiple available run-time environments and the computation results aggregated.

In one embodiment, the simpler sub-processes, each consisting of a set of computation closures can be performed in a run-time environment, wherein the data that the process is being performed on can be easily accessed (e.g. faster, requiring less resources, involving limited number of devices, etc.). For example, if a process is performed in a run-time environment wherein the required data is locally accessible, the data does not have to be transferred remotely. It other words, the computation is brought (e.g. migrated) to the data, instead of data being sent to the computation. This approach can significantly improve bandwidth usage and processing time.

Providing input suggestions based on contextual information to users while browsing the network for information, may significantly improve users' experience. Furthermore, since browsing activity may require extensive manipulation of broadly distributed data, it may involve complex computations involving resource consuming computations which if distributed over multiple run-time environments, the response time and the quality of the response can greatly improve. Current technologies enable a mobile device to locally manipulate contexts such as data and information via the elements of a user interface of the device in order to provide input suggestions. However, using distributed computations and processes related to or acting on the distributed data and information within the information space for providing the input suggestions is not supported. In other words, a user equipment in general does not provide a user with input suggestions by migrating computations to information and applying distributed computations over distributed context information. For example, an input suggestion application that processes context information distributed within one or more information spaces generally executes on a single device (e.g., with all processes and computations of the application also executing on the same device) to operate on the distributed information. In some cases (e.g., when computations are complex, the data set is large, etc.), providing a means to also distribute the related computations in addition to the information space is advantageous. Some of the current information providers, at best, provide input assistance by referring to usage history on the same device based on stored cookies, while some other providers refer to popular queries typed by other users (e.g. Google Instant). However, current systems do not account for current user context for providing useful suggestions to user's knowledge. Furthermore, current systems do not provide semantic information about the expected content or forms, making determination of useful suggestions difficult.

To address this problem, a system 100 of FIG. 1 introduces the capability to provide input suggestions in information management environments. More specifically, the system 100 introduces the capability to provide input suggestions by introduction of the capability to construct, distribute, and aggregate computations as well as their related data. More specifically, to enable a user equipment which connects to the information management environment, to distribute computations associated with input suggestion among other devices with access to the information management environment, each computation is deconstructed to its basic or primitive processes or computation closures. Once a computation is divided into its primitive computation closures, the processes within or represented by each closure may be executed in a distributed fashion and the processing results can be collected and aggregated into the result of the execution of the initial overall computation.

In one embodiment, each high context set of computations associated with input suggestion can be represented as closed sets of processes (e.g. transitive closures) such that closures can be executed separately (e.g. through distributed processing equipments). The transitive closures can be traversed in order to present the granular reflective processes attached to each particular execution context. The mechanism of computation spaces environment provides distributed deductive closures as a recyclable set of pre-computed, computation closures that can be distributed among various devices and infrastructures or being shared among the users of one or more information management environments by being stored on any storage locations related to the information spaces associated with the information management environment.

In another embodiment, the provided distributed computations associated with input suggestion processes may be archived in one or more computation stores throughout the computation space to be accessible for future use. In this embodiment, the information management environment may search the stores for previously generated standalone computations before attempting to generate them. This mechanism provides recyclable computations that can be retrieved and combined into sets to be utilized for providing various services.

As shown in FIG. 1, the system 100 comprises a set 101 of user equipments 107a-107i having connectivity to input generating platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 107a-107i is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 107a-107i can support any type of interface to the user (such as “wearable” circuitry, etc.).

In one embodiment, the owner of each UE 107a-107i has access to information that is distributed throughout the context stores 119a-119m and information stores 113a-113m within the environment of the information management environment 111. The context stores 119a-119m and information stores 113a-113m may be located on the UE 107a-107i where the user can have direct access to or may be accessible to the user via the communication network 105 and information spaces (not shown) within the information management environment 111. It is noted that the information stores 113a-113m include information commonly used and globally accessible by users, providers, systems, etc., whereas context stores 119a-119m contain context information specific to each user such as, for example, personal information, documents, media files, browsing history, etc. Furthermore, computation stores 115a-115m include computation closures that constitute various processes performed on the information in information stores 113a-113m, in context stores 119a-119m, etc. In one embodiment, any of the information stores 113a-113m, context stores 119a-119m, and the computation stores 115a-115m may overlap with each other or may be stored in same or different storage media. The separate representations for information stores 113a-113m, the computation stores 115a-115m, and the context stores 119a-119m are from a logical point of view to show the difference in the nature of their contents, while the stores may physically be collocated in the same storage media.

The information may be identified by its owner as public, which makes it accessible to other users having connectivity to the owner via the communication network, or may have been made private, where the owner can decide the level of accessibility. Each UE 107a-107i has access to its owner's private information and a large volume of public information available to the UE 107a-107i via the communication network 105. Furthermore, a UE 107a-107i may have access to sets of computations specifically assigned to the UE (e.g. computations associated with applications that user of the UE signed up for, default applications setup by the manufacturer, etc.) or sets of computations associated with freely available services such as search engines.

In one embodiment, the input generating platform 103 causes, at least in part, presentation of a user interface element including at least one input field on the UI 109a-109i of a UE 107a-107i. Presentation of the user interface element on the UI 109a-109i may be triggered by user via pressing a button, activating an application, etc. on the UE 107a-107i. The presentation may also be activated automatically based on previously defined setups by the user, manufacturer defaults, etc. Furthermore, the presentation may be activated by other local or remote devices (e.g. other UEs 107a-107n, backend devices, etc.) having connectivity to the UE via communication network 105.

In one embodiment, the input generating platform 103 determines at least one field type associated with the at least one input field. The field type may be determined based, at least in part, on metadata (e.g. data describing the information content of information stores 113a-113m, computations of computation stores 115a-115m, or content of context stores 119a-119m), semantic information (e.g. semantics associated with the information), crowd-sourced data (data determined based on the behavior of a large group of people or community), web-sourced data (data obtained from the communication network), or a combination thereof.

In one embodiment, the input generating platform 103 identifies at least one information store 113a-113m or context store 119a-119m based, at least in part, on the at least one field type. A field type may be used to identify information that is stored based on type. For example, if the input field represents an input for a mapping application, such as an address, one or more information spaces that store address information may be identified, while for an online investment application, the information (or content) stores containing stock information may be identified as relevant.

In one embodiment, following the identification of at least one information store, context store, or a combination thereof, one or more computations are migrated in order to be executed on the identified information and produce input suggestions. The computations may be migrated to a run-time environment wherein their execution can be performed with high efficiency. For example, the computations may be migrated to the same device where the identified information reside, to a device having direct accessibility to the identified information, to a device with highest processing power among available devices, etc. In other embodiments, a set of computations for generating suggestions may be broken into smaller sub-sets of computations, sub-sets executed in different run-time environments and execution results aggregated for generating input suggestions.

In one embodiment, the input generating platform 103 may store generated suggestions in suggestion store 117. The stored suggestions may be reused for generating further similar input fields. Additionally, a user of UE 107a-107n may select one or more suggestions to be stored either locally on the UE or distributed on the information management environment associated with the user, and reuse or share them with other users. The stored suggestions by the input generating platform 103 or by the user of the UE 107a-107n may also be used for providing crowd-sourced or web-sourced information.

In one embodiment, the information management environment 111 may be managed by or connected to a semantic web 121, wherein the semantic web 121 has connectivity to UE 107a-107n via the communication network 105. As used herein, the term semantic web refers to a universal medium for data, information, and knowledge exchange based on computer-comprehensible meaning (semantics) derived from the data, information, or knowledge. In one embodiment, the semantic web is set of interconnected or otherwise related documents, data, information, knowledge, computations, or a combination thereof. By way of example, knowledge (or information) and processes in the semantic web are generally structured and organized at a finer level of granularity than information or knowledge contained within free-text documents or processes of certain applications.

By way of example, the UE set 101 and the input generating platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

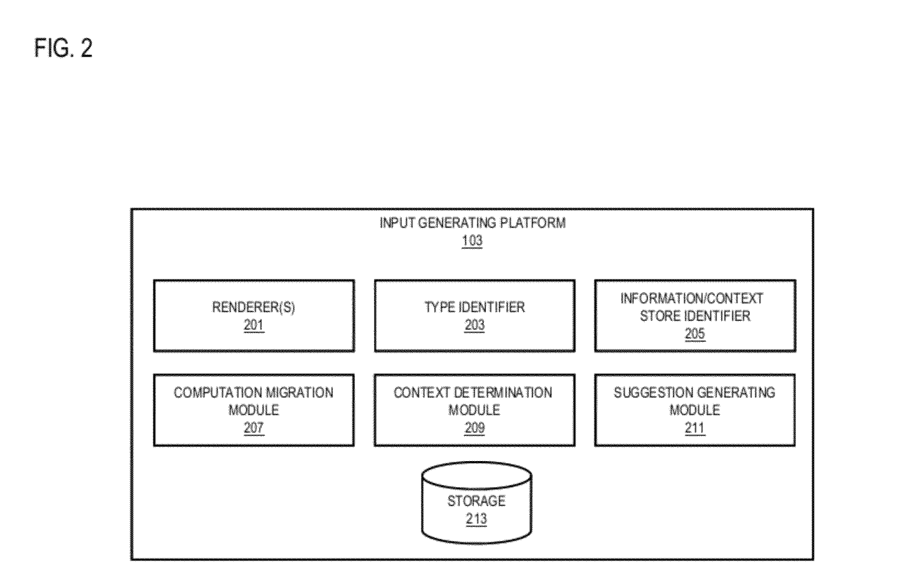

FIG. 2 is a diagram of the components of input generating platform, according to one embodiment. By way of example, the input generating platform 103 includes one or more components for providing input suggestions. It is contemplated that the functions of these components may be combined in one or more components or performed by other components of equivalent functionality. In this embodiment, input generating module 103 includes one or more renderers 201, type identifier 203, information/context store identifier 205, computation migration module 207, context determination module 209, suggestion generating module 211 and storage 213.

In one embodiment, a renderer 201 causes at least in part presentation of a UI 109a-109i element including at least one input field to a UI 109a-109i of UE 107-107i. A renderer 201 may utilize graphic representation components of the UE to present the graphical representation defined for the input field on the UI screen. The renderer 201 may also handle and present a provisional set of input suggestions or one or more default values to the user. The input field may include a text field, a multimedia field (e.g., sound, image, video, etc.), or a combination thereof.

In one embodiment, the input field may be presented to the user via UI prior to generating input suggestions wherein other embodiments may include suggestion generating prior to input field presentation. Furthermore, a renderer may consist of several components, wherein each may be associated with presenting one or more input fields.

As previously noted, a renderer may be activated by user of the UE 107a-107i via pressing a button, activating an application, etc. The input field rendering may also be activated automatically based on previously defined setups by the user, manufacturer defaults, etc. Furthermore, the renderer may be activated by other local or remote devices (e.g. other UEs 107a-107n, backend devices, etc.) having connectivity to the UE via communication network 105.

In one embodiment, the type identifier 203 determines at least one field type associated with the at least one presented input field. The field type may be different for different kinds of renderers 201. For example, in a web browsing environment, a renderer 201 may be able to handle practically all kinds of information, while a renderer 201 used in a specific application may only need to concern itself with few types relevant to the application. The renderer 201 may also contain an implementation for the computation of input suggestions, or only a function prototype without an implementation, assuming that the function is implemented in the information management environment 111. The type identifier 203 may refer to data such as the configuration and type of renderer 201, the entity that activated the renderer (e.g. the application, the user, etc.), instructions used or parameters entered during activation of the renderer 201, etc.

In one embodiment, the type identifier 203 may determine the at least one field type based, at least in part, on metadata, the data that describes other information such as renderer 201 configuration, instructions and parameters, etc. The type identifier 203 may also determine the field type based on crowd-source information saved by users, UEs 107a-107i, input generating platform 103, or by any other entity for further use. The type identifier 203 may further determine the field type based on web-sourced data made available to the public via the communication network 105 from different sources. The type identifier 203 may perform statistical analysis on the data and determine the field type based on the analysis results. In other embodiments, the type identifier 203 may receive one or more inputs for specifying the at least one field type. The input may be directly entered by the user of the UE 107a-107i. Following identification of the field type, the type identifier 203 may store the identified field types in storage 213, directly pass it to information/context store identifier 205, or a combination thereof.

In one embodiment, the information/context store identifier 205 identifies at least one information store 113a-113m or context store 119a-119m based, at least in part, on the at least one determined field type. The information/context store identifier 205 may search in the information management environment 111 for identifying the at least one or more information store, context store, or a combination thereof that include information relevant to the identified type. The information/context store identifier 205 may also search the suggestion store 117, storage 213, any other sources having connectivity to via the communication network 105, or a combination thereof to identify information (or context) stores whose contents may be used as input.

In one embodiment, the context determination module 209 may determine context information, semantic information, or a combination thereof associated with the user interface 109a-109i element, a UE 107a-107i at which the user interface element is presented, a user of the UR 107a-107i, the at least one identified input field, or a combination thereof, wherein the identifying of the at least one information store 113a-113m or context store 119a-119m is based, at least in part, on the determined context information, the semantic information, or a combination thereof. The context information or the semantic information may be determined from one or more local storages at UE 107a-107i, on information management environment 111 or in other locations accessible to the input generating platform 103 via the communication network 105.

In one embodiment, the information/context store identifier 205 may store a list of or pointers to the information (or context) stores found, in the storage 213, in suggestion store 117 or a combination thereof. The information/context store identifier 205 may also directly pass the links to identified information (or context) stores to the computation migration module 207. Once the relevant information (or context) stores are identified, the computation migration module 207 determines to migrate one or more computations for generating one or more suggestions, one or more default values, or a combination thereof for populating the at least one input field, generating the user interface 109a-109i element, or a combination thereof to the at least one information store 113a-113m or context store 119a-119m.

In one embodiment, the computation migration module 207 determines one or more local computations for generating the one or more suggestions. The local computations may be located in local storage spaces of one or more UEs 107a-107i, in local spaces of one or more backend devices (not shown) having connectivity to the UEs 107a-107i and the information management environment 111 via the communication network 105, or a combination thereof. In other embodiments, if local computations are not determined, the computation migration module 207 may look into remote sources for computations related generating suggestions for the at least one input field, the user interface 109a-109i element, or a combination thereof. The computation migration module 207 may also store the determined computations in the storage 213, in suggestion store 117 or a combination thereof. The computation migration module 207 may also directly pass the links to identified computations to the suggestion generating module 211.

In one embodiment, the suggestion generating module 211 uses the at least one field type (determined and stored the type identifier 203), the one or more computations (determined and stored by the computation migration module 207), the stored one or more suggestions (contained in suggestion store 117), or a combination thereof to generate at least one presentation of the UE 109a-109i element, the at least one input field, or a combination thereof. In one embodiment, the generating of suggestions is performed in the device (UE 107a-107i, backend, information store 113a-113m, context store 119a-119m, etc.) wherein the determined context information resides in order to avoid transfer of large amounts of data over the network. Therefore, for example, if all the needed context information for one or more input types reside in the UE 107a-10i, no computation migration will be necessary. In other embodiments, wherein the input generating is performed remotely from the device wherein the input field is displayed, the input generating platform 103 sends the generated suggestions to the device for the input field to be populated based on. The one or more suggestions may be provided as text, multimedia objects (e.g. sound, image, video, etc.), or a combination thereof.

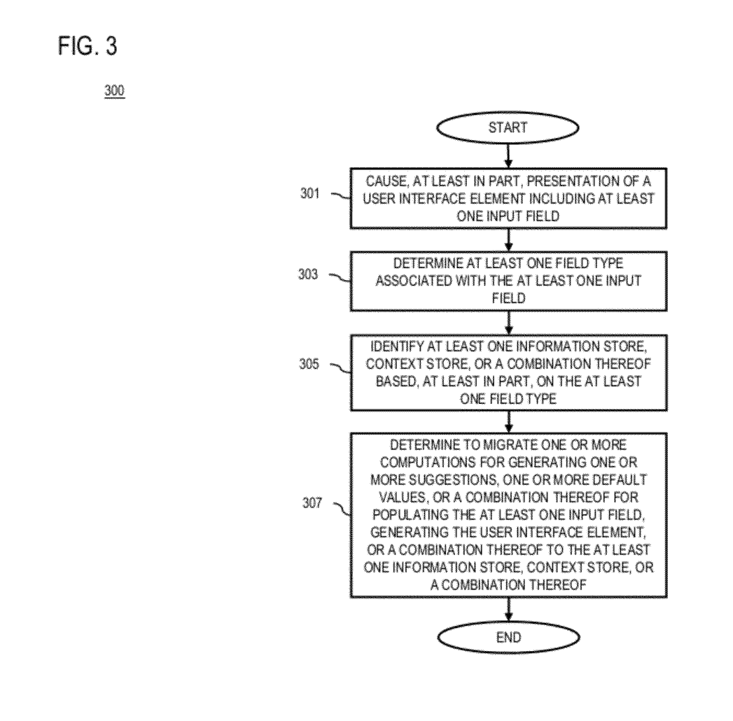

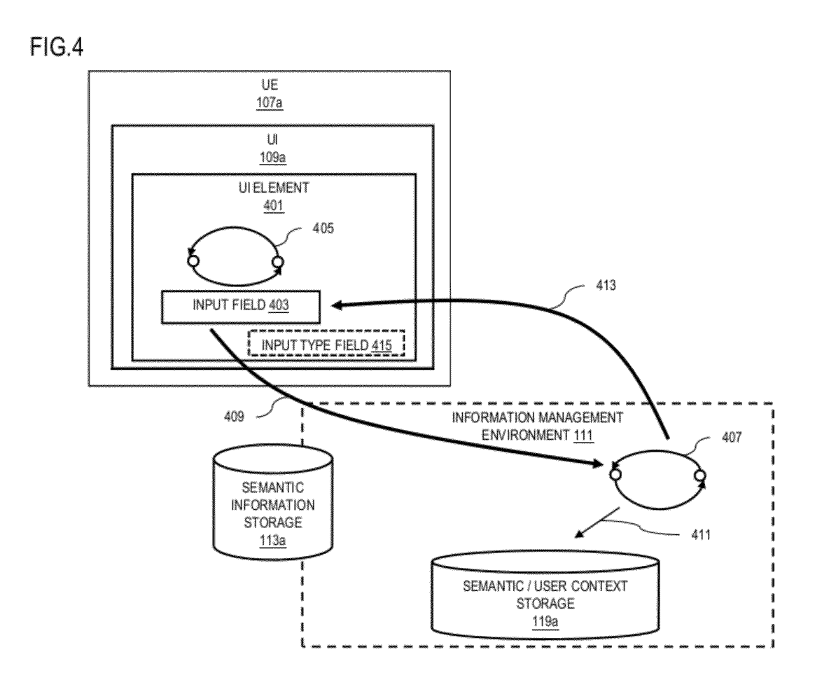

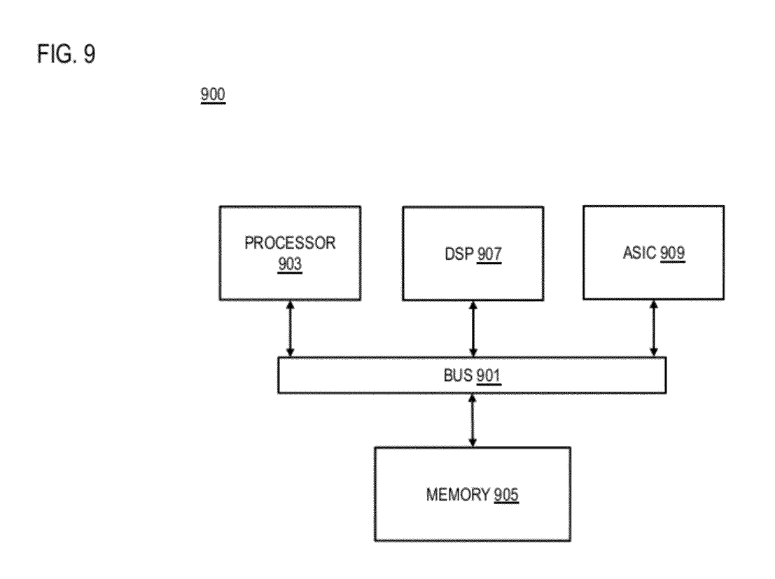

FIG. 3 is a flowchart of a process for providing input suggestions, according to one embodiment. In one embodiment, the input generating platform 103 performs the process 300 and is implemented in, for instance, a chip set including a processor and a memory as shown in FIG. 9. The flowchart of FIG. 3 is described with respect to the diagram of FIG. 4, wherein FIG. 4 is a diagram of input field rendering, according to one embodiment.

In step 301, the renderer 201 of the input generating platform 103 causes, at least in part, presentation of a user interface element 401 on the user interface UE 109a of a device (e.g., UE 107a. The UI element 401 may include one or more boxes, one or more input fields 403 which may include dropdown menus, place holders, images, videos, etc., depending on the information needed by the application that the UI element 401 is associated with. For example for a map application, the UI element 401 may include an address box. Per step 303 the type identifier 203 from the input generating platform 103 determines at least one field type associated with the at least one input field 403. The field type information may be found locally in UE 107a or remotely on any of information stores 113a-113m, or context stores 119a-119m from the information management environment 111. Furthermore, the computations needed for determining the field type may locally exist on the UE 107 (shown as graph 405 in FIG. 4) or exist remotely in computation stores 115a-115m from the information management environment 111.

In one embodiment, if the field type information and field type determination computations are all locally determined on UE 107a the process of field type determination by the type identifier 203 can be performed locally, in another embodiment if the computation 405 is local but the information is remote, the input generating platform 103 may migrate the computation 405 to the information management environment 111 wherein the computation 405 can be performed on the determined information in order to determine the field type. In yet another embodiment, both the field type information and field type computation may be found in the information management environment 111. In this embodiment the computation 405 may be migrated within the information management environment 111 to a run time environment with efficient accessibility to the information it is going to be performed on.

Following the determination of the input field type, per step 305, the information/context store identifier 205 of the input generating platform 103 identifies at least one information store, context store, or a combination thereof based, at least in part, on the determined field type. As an example, for a mapping application, in order to generate suggestions for an input field with the field type as address (e.g. mailing address), the input generating platform 103 may search the information stores 113a-113m or context stores 119a-119m within the information management environment 111 for address information. The information/context store identifier 205 may use other local or global data for a more specific identification of the relevant information stores 113a-113m or context stores 119a-119m. For example, the information/context store identifier 205 may use the current location of the UE 107a for suggesting address entry inputs to UE 107a. The information/context store identifier 205 may also use any data shared by the user of UE 107a or other users on the network for spotting relevant information stores 113a-113m or context stores 119a-119m. For example, the information/context store identifier 205 may include information (or context) stores containing information on popular landmarks among friends, neighbors, and co-workers of the user of UE 107a or landmarks popular among users with similar interests as the user of UE 107a. The identified information (or context) stores may be storages containing the user's (or the other users') context store 119a, general semantic information 113a, or a combination thereof.

Per step 307, the computation migration module 207 of the input generating platform 103 determines the computations for generating the input suggestions for input field 403 based on the determined field type and identified information/context stores 119a, 113a, etc.

As previously discussed, the computations may exist locally on the UE 107, or distributed throughout the information management environment 111. The context determination module 209 determines and retrieves the information associated with the input field and the computation migration module 207 migrates the computations (either from local storage or from other remote storages) to a location on the information management environment 111 where the information that the computation is being performed on is accessible efficiently (e.g., wherein a lowest possible volume of data has to be transferred among various components of the network). The computation migration is shown as arrow 409 in FIG. 4, wherein the computations 405 are migrated to information management environment 111 as computations 407.

In one embodiment, as per arrow 411 the migrated computations 407 are performed on the identified information in the context store 119a by the suggestion generating module 211 and the execution results which are a set of at least one input suggestions are sent to the UE 107a via arrow 413. Subsequently, the rendered 201 presents the received suggestion in the UI element 401 in the input field 403 for the user to select the best match to their needs.

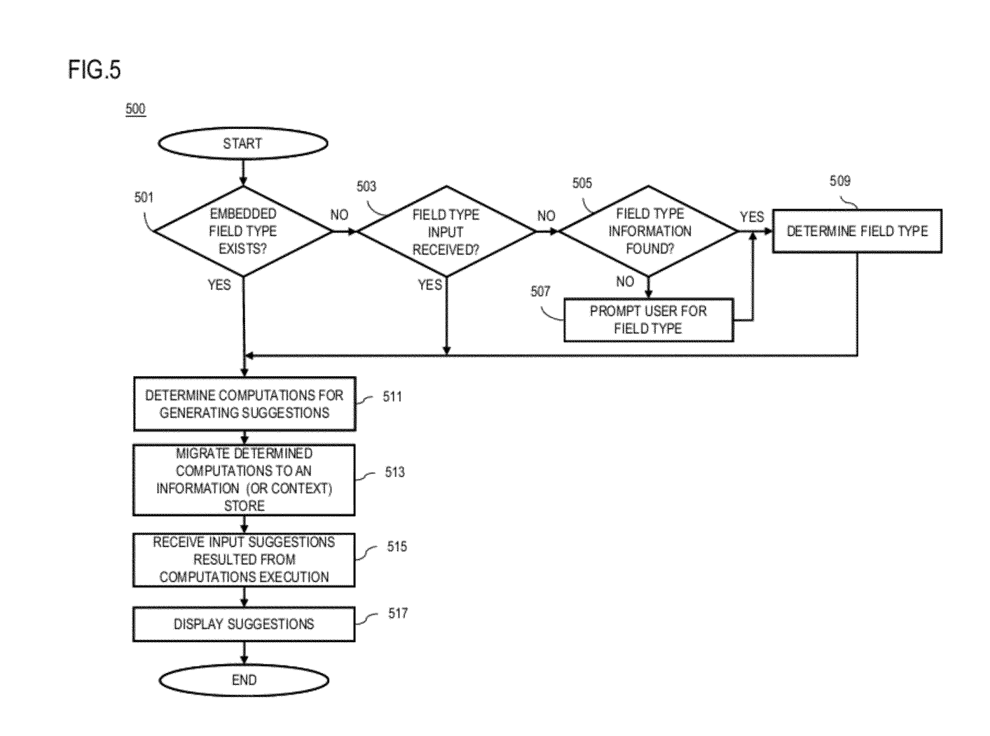

FIG. 5 is a flowchart of generating input suggestions, according to one embodiment. The flowchart of FIG. 5 is described with respect to the diagram of FIG. 4. In one embodiment, per step 501 the type identifier 203 determines whether the field type for the input field 403 is embedded in the presentation of input field 403 in UI element 401. If the field type exists as embedded in the UI element, the input generating platform 103 may not need to identify the field type by searching and extracting type information as described in FIG. 3. In this embodiment, per steps 511-517 (similar to steps 305 and 307) the process of determination of computations, computations migration, transfer of input suggestions, and rendering of suggestions is performed. The description of the steps 511-517 are not repeated here, but have been discussed in the description of FIG. 3.

In one embodiment, if the embedded field type is not found in the UI element 401, per step 503 the input generating platform 103 verifies whether the input type is being entered by the user of the UE 107a. In various embodiments, the application presenting the UI element 401 may provide the user of the UE 107a with the option to specifically identify the field type for the input field 403. In one embodiment, the application may provide an input type field 415 for each input field so that the user can specifically enter the type. Furthermore, the input generating platform 103 may be setup to generate field type suggestions in a way similar to input suggestions.

In one embodiment, if the field type is neither embedded in UI element 401, nor entered by user in field 415, per step 505 the type identifier 203 searches for field types relevant to the application and the UI element as described in FIGS. 2 and 3. If no field type is found, the input generating platform 103 may prompt the user that input suggestions cannot be provided. Otherwise, if the type is determined the input generating process will continue as described with regard to FIG. 3.

It is noted that, in some occasions no input suggestions may be found. For example, for a new application wherein no sample input is provided by the manufacturer, no information regarding previously used inputs exists on the UE 107a or on the information management environment 111, or the existing information is privately owned by some other entities and therefore is not sharable, the results from the execution of computations may be empty. In this embodiment, the input generating platform 103 may prompt user of the UE 107a, that no input suggestions found.

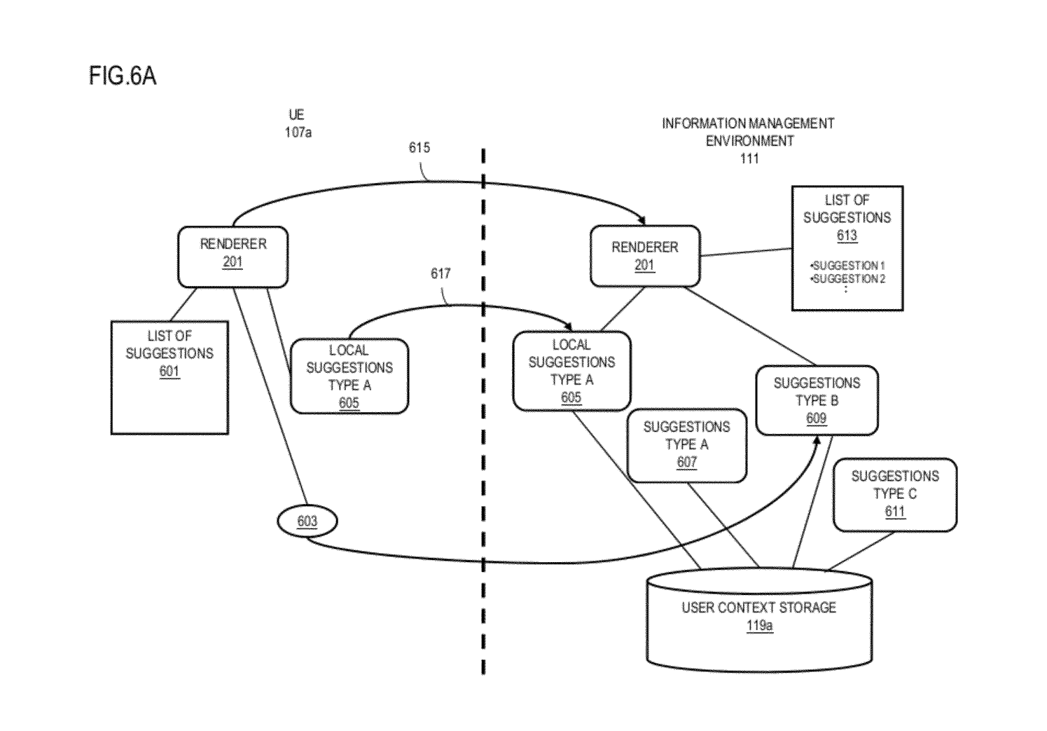

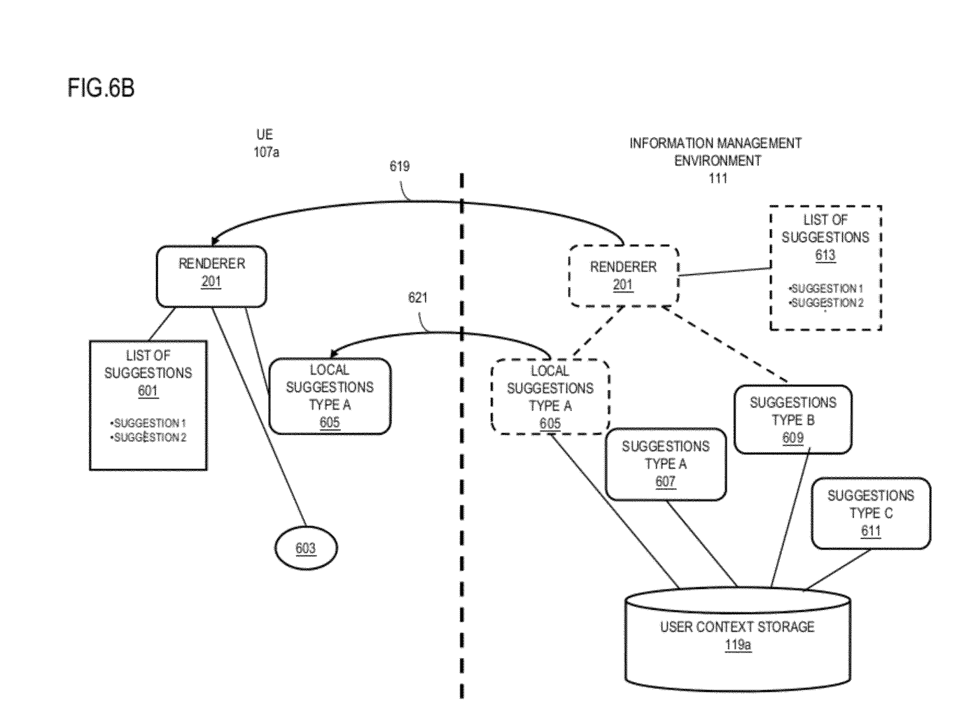

FIGS. 6A-6B are diagrams of computation migration, according to various embodiments. FIG. 6A is a diagram of computation migration from UE 107 to information management environment 111, while FIG. 6B is a diagram of migration of computation results from information management environment 111 to UE 107 for presentation to the user equipment UE 107a. In one embodiment, a renderer 201 presents and handles the input field 403 in the UI element 401 of UI 109a of UE 107a. The renderer 201 may also handle the provision of the suggestions generated by input generating platform 103 or the default value embedded in the UI element 401, to the user of UE 107a. In one embodiment, The UI element 401 may be presented to the user before the suggestions are computed by performing the computations. In other embodiments, the UI element 401 may be presented to the user following the completion of computations execution. Furthermore, in some embodiments, the renderer 201 may consist of several parts (sub-renderers) wherein each part may function independent from each other or interchangeably.

In one embodiment, the renderer 201 may contain a list of possible suggestions 601 to be offered to the user. The list 601 may initially be empty or possibly contain some pre-assigned values (e.g. default values). The renderer 201 may also contain calls to suggestion generating module 211 that generates suggestions for relevant field types of expected input. Furthermore, in some embodiments the relevant field types may differ for different kinds of renderer 201. For example, a renderer 201 in a web browser application may be able to handle practically all types of information, while a renderer 201 used in a specific application may only need to consider few field types relevant to the application.

In one embodiment, the renderer 201 may include the functions for generating suggestions or include prototypes of the functions without an implementation, assuming that the function is executed in the environment of the information management environment 111.

As previously described, the field types used to generate the input suggestions may reside on UE 107a, in the information stores 113a-113m, or in context stores 119a-119m of the information management environment 111 (context storage 119a shown). Nevertheless, the computation of suggestions are performed in an environment where either the information (e.g. context information) exists or easily accessible, in order to avoid moving large volumes of data over the network. Therefore, if all needed information and computations for some input type resides in the UE 107a, there may be no need to migrate the computation out from the UE 107a.

In one embodiment, as seen in FIGS. 6A and 6B, block 605 shows local field type A that reside on UE 107a while blocks 607-611 show field types A, B and C that reside on the information management environment 111. In this embodiment, the renderer 201 and the local types 605 are migrated respectively via arrows 615 and 617, to the information management environment 111, wherein the majority of the types reside. The suggestion list 613 is then generated by the input generating platform 103 based on the suggestions. Block 603 represents a pointer to the field type B. In this case even though the Type B is residing on the information management environment 111, it is accessible by the rendered 201 via link 603.

In one embodiment, as seen in FIG. 6B, following the completion of the suggestions generating, the results 613, the renderer 201 and the local types 605 migrate back to the UE 107a, via arrows 619 and 621. The suggestion list 601 can be updated based on the suggestion list 613 and presented to the user of UE 107a via the input field 403 of UI element 401.

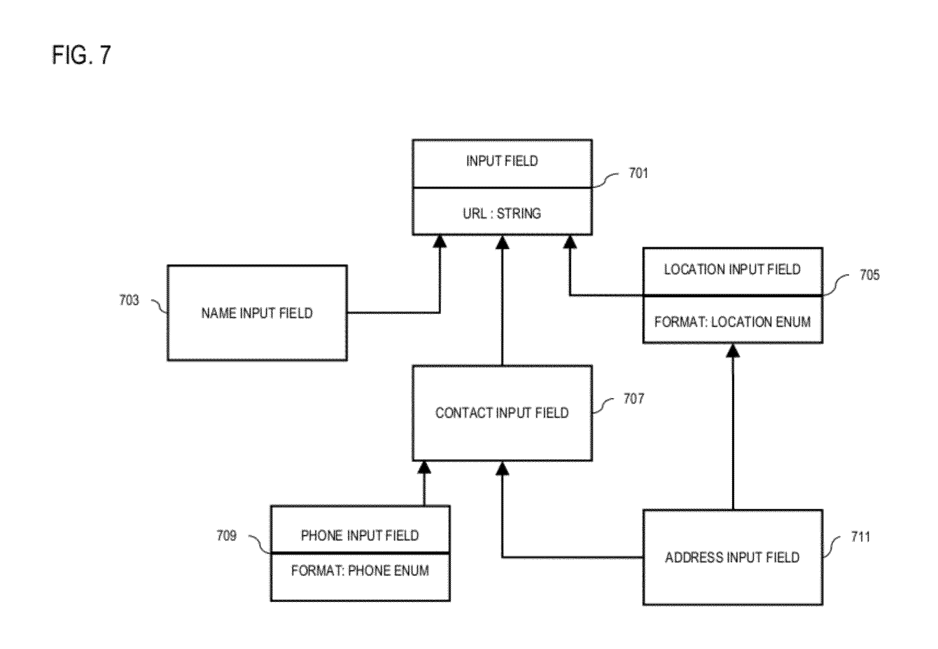

FIG. 7 is a diagram of an ontology for storing semantic information of input fields, according to one embodiment. In various applications available to the users of the devices such as UEs 107a-107i, and specifically for applications available via the Web, it is difficult to determine the type of input that is expected to be entered into the input forms in various web pages. In such circumstances, having a central storage for crowd-sourced information, provided by friends, acquaintances, or by the public crowd accessing and using the webpage, and made accessible to everyone, can be very beneficial. An example of a general structure of ontology for such storage is presented in FIG. 7. The main issue in storing semantic input field information is the identification of each input field.

In one embodiment, each field may be identified by using a URL in web forms similar to the structure of applications running on the UE 107a. In this embodiment, links to field types that are found in existing ontologies provide an easy way to search for suitable candidates for inclusion in input suggestions. As seen in the example of FIG. 7, a URL with a string type is assigned as the type of the input field 701. The name input field 703 is linked to the input field 701. The link among input fields 703 and 701 indicates that the name input field 703 is from the same type of the input field 701. Similarly, links between location input field 705 and contact input field 707 determine that both fields 705 and 707 are from the input field type. Therefore, one URL used for the type of input field 701 can be applied to fields 703, 705, and 707 without the need for each field to have an individual type assigned to it. However, the location input field 705 may require format information which is not provided in the URL of input field 701. In this case the format information is separately added to the location input field 705.

Furthermore, address input field 711 is linked to the contact input field 707 and the location input field 705. The two links may identify that the address input field 711 can be considered either a contact field or a location field, or both. The address input field 711 inherits the type URL from input field 701 and the format from location input field 705. Also the phone input field 709 is linked to the contact input field 707. This link states that phone input field 709 is a contact input field with a certain format of a phone number. The phone input field 709 inherits the type URL from input field 701 while having its own specific format.

The processes described herein for providing input suggestions may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

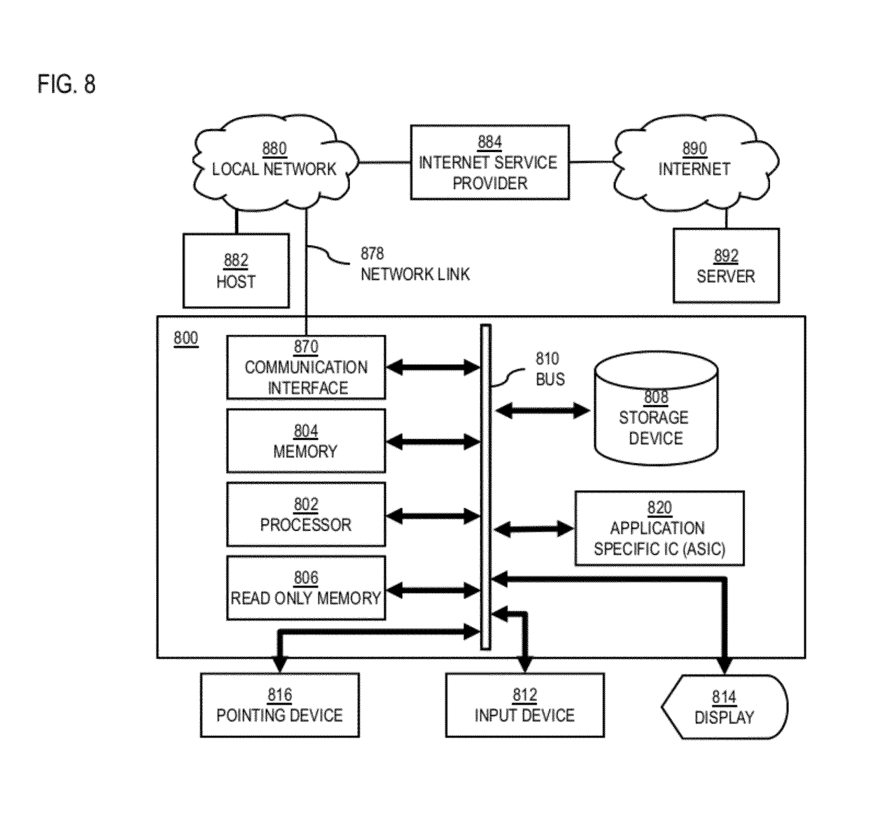

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide input suggestions as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing input suggestions.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to providing input suggestions. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for providing input suggestions. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing input suggestions, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing input suggestions to the UE set 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to provide input suggestions as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing input suggestions.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide input suggestions. The memory 905 also stores the data associated with or generated by the execution of the inventive steps.

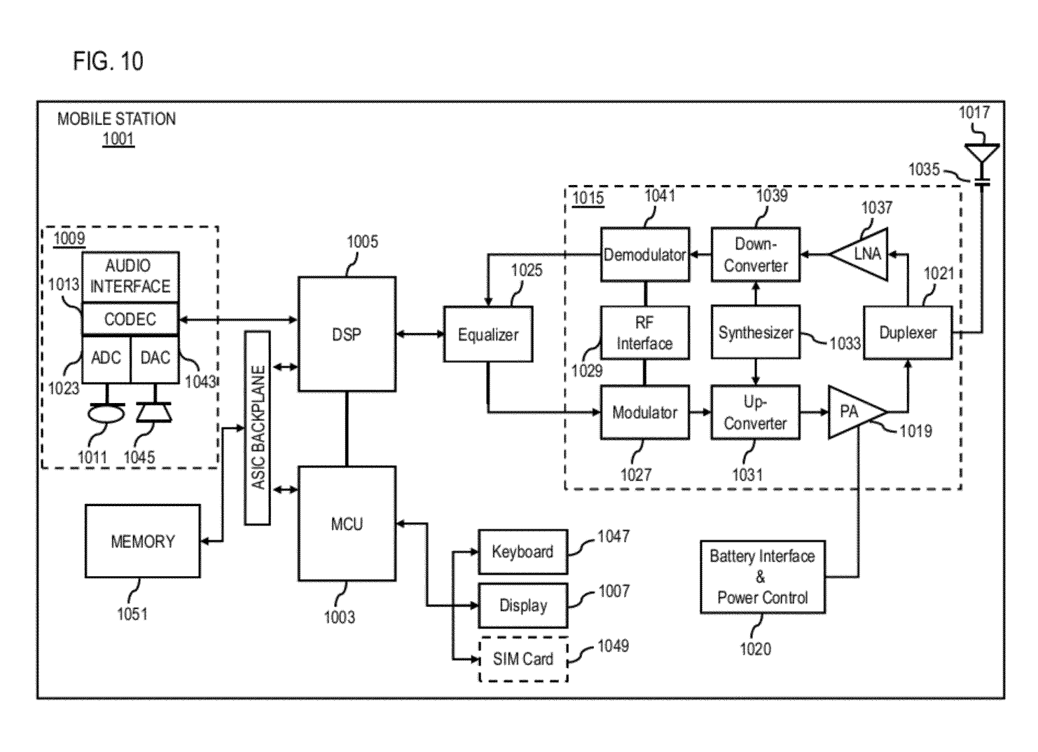

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of providing input suggestions. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing input suggestions. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide input suggestions. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a presentation of a user interface element including at least one input field;
at least one field type associated with the at least one input field;
at least one information store, context store, or a combination thereof based, at least in part, on the at least one field type; and
a local and/or remote determination to migrate one or more computations for generating one or more suggestions, one or more default values, or a combination thereof for populating the at least one input field, generating the user interface element, or a combination thereof to the at least one information store, context store, or a combination thereof.

2. A method of claim 1, wherein the (1) data and/or (2) information and/or (3) at least one signal are further based, at least in part, on the following:
the one or more computations from the at least one information store, context store, or a combination thereof; and
a rendering of the user interface element based, at least in part, on the one or more computations.

3. A method of claim 1, wherein the (1) data and/or (2) information and/or (3) at least one signal are further based, at least in part, on the following:
one or more local computations for generating the one or more suggestions; and
a rendering of the user interface element based, at least in part, on the one or more local computations, the one or more computations, or a combination thereof.

4. A method of claim 1, wherein the (1) data and/or (2) information and/or (3) at least one signal are further based, at least in part, on the following:
a local and/or remote determination of the at least one field type based, at least in part, on metadata, semantic information, crowd-sourced data, web-sourced data, or a combination thereof associated with the user interface element, the at least one input field, or a combination thereof.

5. A method of claim 1, wherein the crowd-sourced data is based, at least in part, on one or more inputs specified for the at least one input field by one or more users.

6. A method of claim 1, wherein the (1) data and/or (2) information and/or (3) at least one signal are further based, at least in part, on the following:
an input for specifying the at least one field type.

7. A method of claim 1, wherein the (1) data and/or (2) information and/or (3) at least one signal are further based, at least in part, on the following:
context information, semantic information, or a combination thereof associated with the user interface element, a device at which the user interface element is presented, a user of the device, the at least one input field, or a combination thereof,
wherein the identification of the at least one information store, context store, or a combination thereof, is based, at least in part, on the context information, the semantic information, or a combination thereof.

8. A method of claim 1, wherein the (1) data and/or (2) information and/or (3) at least one signal are further based, at least in part, on the following:
a local and/or remote determination to store the at least one field type, the one or more computations, the one or more suggestions, or a combination thereof,
wherein the stored at least one field type, the stored one or more computations, the stored one or more suggestions, or a combination thereof are used to generate at least one subsequent presentation of the user interface element, the at least one input field, or a combination thereof.

9. A method of claim 1, wherein the at least one input field includes a text field, a multimedia field, or a combination thereof, and wherein the one or more suggestions are provided as text, multimedia objects, or a combination thereof.

10. A method of claim 1, wherein the information store, context store, or a combination thereof, is a local store, a remote store, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, presentation of a user interface element including at least one input field;
determine at least one field type associated with the at least one input field;
determine at least one information store, context store, or a combination thereof, based, at least in part, on the at least one field type; and
determine to migrate one or more computations for generating one or more suggestions, one or more default values, or a combination thereof for populating the at least one input field, generating the user interface element, or a combination thereof to the at least one information store, context store, or a combination thereof.

12. An apparatus of claim 11, wherein the apparatus is further caused to:
receive the one or more computations from the at least one information store, context store, or a combination thereof; and
cause, at least in part, rendering of the user interface element based, at least in part, on the one or more computations.

13. An apparatus of claim 11, wherein the apparatus is further caused to:
determine one or more local computations for generating the one or more suggestions; and
cause, at least in part, rendering of the user interface element based, at least in part, on the one or more local computations, the one or more computations, or a combination thereof.

14. An apparatus of claim 11, wherein the apparatus is further caused to:
determine the at least one field type based, at least in part, on metadata, semantic information, crowd-sourced data, web-sourced data, or a combination thereof associated with the user interface element, the at least one input field, or a combination thereof.

15. An apparatus of claim 11, wherein the crowd-sourced data is based, at least in part, on one or more inputs specified for the at least one input field by one or more users.

16. An apparatus of claim 11, wherein the apparatus is further caused to:
receive an input for specifying the at least one field type.

17. An apparatus of claim 11, wherein the apparatus is further caused to:
determine context information, semantic information, or a combination thereof associated with the user interface element, a device at which the user interface element is presented, a user of the device, the at least one input field, or a combination thereof,
wherein the determination of the at least one information store, context store, or a combination thereof, is based, at least in part, on the context information, the semantic information, or a combination thereof.

18. An apparatus of claim 11, wherein the apparatus is further caused to:
determine to store the at least one field type, the one or more computations, the one or more suggestions, or a combination thereof,
wherein the stored at least one field type, the stored one or more computations, the stored one or more suggestions, or a combination thereof are used to generate at least one subsequent presentation of the user interface element, the at least one input field, or a combination thereof.

19. An apparatus of claim 11, wherein the at least one input field includes a text field, a multimedia field, or a combination thereof, and wherein the one or more suggestions are provided as text, multimedia objects, or a combination thereof.

20. An apparatus of claim 11, wherein the information store, context store, or a combination thereof, is a local store, a remote store, or a combination thereof.
